(19) United States
(12) Patent Application Publication
(10) Pub. No.: US 2003/0217861 A1
(43) Pub. Date: Nov. 27, 2003

(54) Insulated wire splice

(76) Inventors: David Anthony Skotek, Harrisburg, PA (US); John Henry Weaver JR., Marietta, PA (US); William J. Rudy JR., Annville, PA (US)

Correspondence Address: Michael J. Aronoff, Tyco Electronics Corporation, MS R20/2B, 307 Constitution Drive, Menlo Park, CA, 94025-1164, US

(21) Appl. No.: 10/442,907

(22) Filed: May 20, 2003

Related U.S. Application Data
(60) Provisional application No. 60/382,542, filed on May 21, 2002.

(51) Int. Cl. H01R 4/00

(52) U.S. Cl. 174/84 C

(57) ABSTRACT

An insulated wire splice is provided that includes a wire connector configured to receive and be secured to a wire and an insulating film cover is secured to the wire connector. The wire connector has a body with at least one of a crimp finger and a side extension that is configured to be crimped to the wire. The wire connector and the film cover are configured to form a substantially U-shaped channel.

### CROSS REFERENCE TO RELATED APPLICATIONS

This application claims the benefit of U.S. Provisional Application No. 60/382,542 filed May 21, 2002.

### BACKGROUND OF THE INVENTION

The invention generally relates to wire splices, and more particularly to insulated wire splices.

In the past, a variety of wire splices have been proposed for connecting bare ends or leads on an insulated wire. Different splices are used for different environments and applications. Typically, a wire splice is a metal wire barrel, that is bent or crimped around a wire. The wire barrel may include serrations and burrs located at the top of the serrations. During the crimping operation the burrs pierce the insulative coating or varnish of the wire, for example, a magnet wire and the serrations seat in the bare conductors of the wire, creating a metal-to-metal connection.

In some applications, splices are designed to terminate a magnet wire to itself or to combine the wire with a standard solid or multi-stranded lead wire. In a one-step crimping operation, the magnet wire is automatically ring-stripped of its insulation as it is forced into the wire barrel serrations. The result produces a high strength connection. A plurality of magnet wires can be terminated simultaneously in one barrel. A copper or aluminum magnet wire or a combination of both can be terminated in the splice.

One example of a wire splice is sold under the trademark AMPLIVAR, manufactured and sold by Tyco Electronics Corporation, Harrisburg, Pa. This wire splice includes a compression crimp that eliminates cold solder points, weld burns, and wire embrittlement usually connected with thermal-type terminations. These splices provide excellent tensile strength and are vibration resistant. They also provide an electrical connection that is free of contaminants, such as stripper residue and solder flux. Terminating these splices to precision-formed, strip-fed terminals in automated machines assures high production rates at a low applied cost. The ability to precisely control crimp termination helps eliminate human error for maximum reliability.

While the foregoing wire splices provide excellent electrical termination, they are exposed to the environment. To shield the wire splices from the environment, factory workers manually wrap an insulating tape about the splice, thereby covering any exposed conductors. This is a time consuming, labor intensive process which adds costs and the potential for error to the final product. A need exists for a wire splice which does not require an additional manual insulation wrapping step during manufacturing.

### BRIEF DESCRIPTION OF THE INVENTION

In one embodiment, an insulated wire splice is provided that includes a wire connector configured to receive and be secured to a wire, an insulating film cover secured to the wire connector, and an insulated carrier strip joined with the film cover. The wire connector has a body with at least one of a crimp finger and a side extension configured to be crimped to the wire. The wire connector and the film cover are bent to form a channel that is configured to receive wire.

In another embodiment, a method is provided for splicing a wire that includes providing an insulated film strip having a plurality of film covers therein. Each film cover joins an insulated carrier strip and secures a plurality of wire connectors to corresponding film covers. The method includes stamping the wire connectors to form a body having opposed crimp fingers and opposed side extensions and stamping lateral notches in the film strip to separate adjacent metal connectors and adjacent film covers. The method further includes folding the crimp fingers, side extensions and corresponding film covers to form a channel configured to receive a wire.

In a further embodiment, a contact assembly is provided that includes an insulated carrier film formed integral with a series of film covers and a series of contacts held on corresponding film covers. The series of contacts are adhesively secured to the corresponding film covers. The series of contacts include a body having at least one of a crimp finger and a side extension configured to be crimped to a wire. The series of contacts and the corresponding film covers are bent to form an open barrel.

### BRIEF DESCRIPTION OF THE DRAWINGS

FIG. 1 is a top view of a length of material formed according to an embodiment of the present invention.

FIG. 2 is a perspective view of a plurality of insulated wire splices formed according to an embodiment of the present invention while at various stages of manufacturing.

FIG. 3 is a top perspective view of a pre-crimped, insulated wire splice coupled to a carrier strip formed according to an embodiment of the present invention.

FIG. 4 is a side view of the wire splice in FIG. 3.

FIG. 5 is a front view of the wire splice in FIG. 3.

FIG. 6 is a top perspective view of a crimped insulative wire splice securing the wire therein according to an embodiment of the present invention.

### DETAILED DESCRIPTION OF THE INVENTION

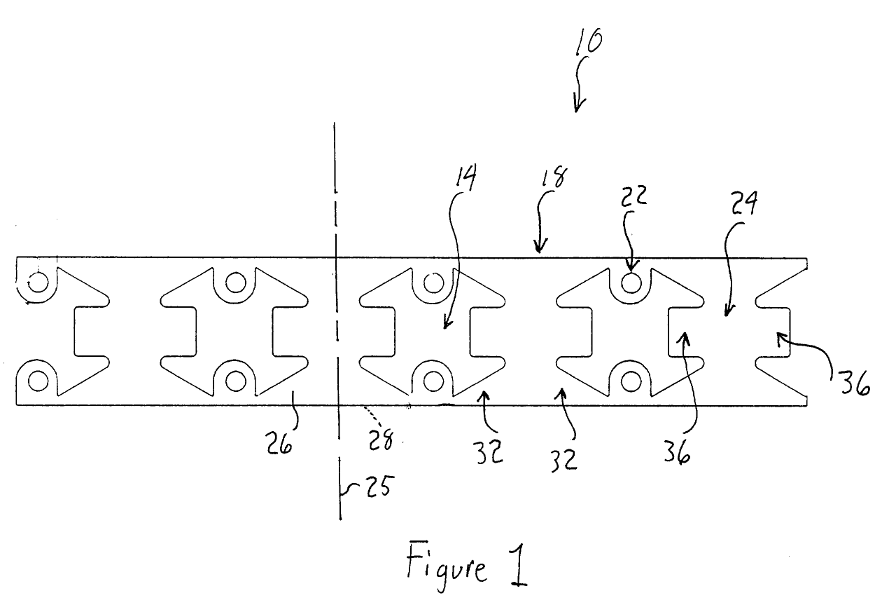

FIG. 1 is a top view of a metal strip 10 formed according to an embodiment of the present invention. The metal strip 10 is used to make wire splices. Optionally, the metal strip 10 maybe a brass strip. The metal strip 10 is stamped by a progressive tooling machine to remove metal material leaving a series of adjacent contacts or metal connectors 18 separated by openings 14. The metal strip 10 is stamped such that a portion of metal material 22 remains for coupling adjacent metal connectors 18 together. Each metal connector 18 has a body 24 extending along a longitudinal axis 25. Each body 24 has a top surface 26 and a bottom surface 28. The body 24 includes at least one of a crimp finger 32 and a side extension 36. Optionally, each body 24 includes at least one of a pair of opposed crimp fingers 32 and a pair of opposed side extensions 36.

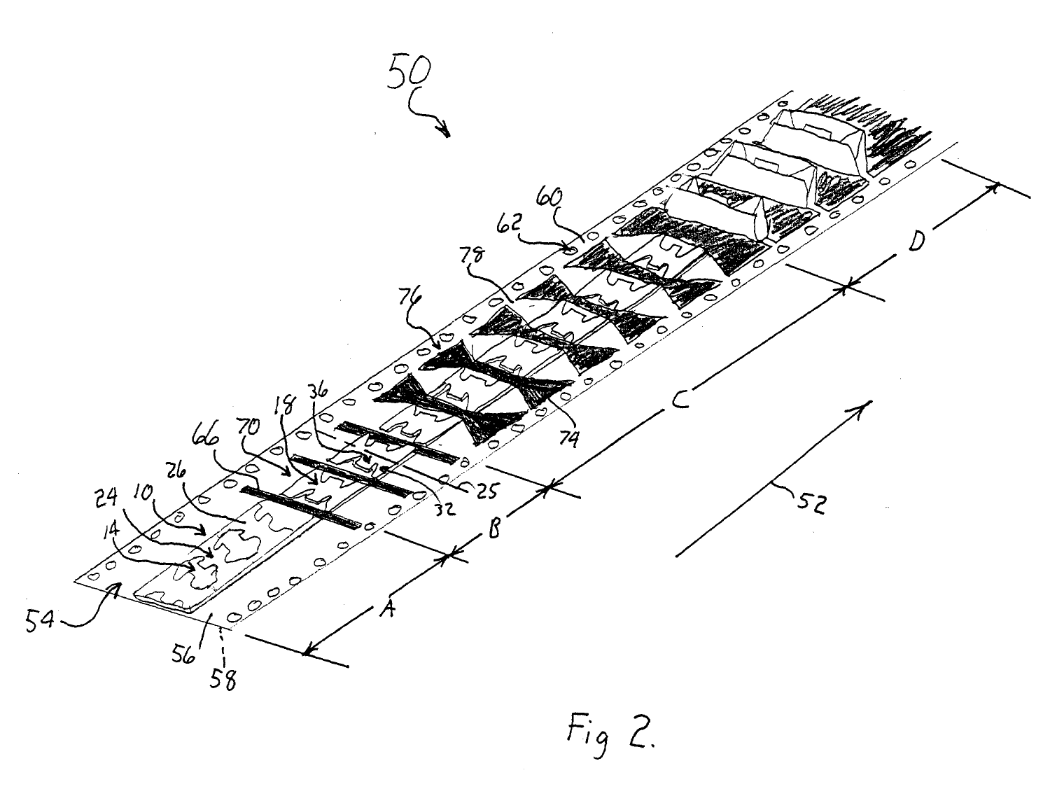

FIG. 2 is a perspective view of a plurality of insulated wire splices 50 provided at various stages of manufacturing. The stages of manufacturing through which insulated wire splices 50 pass, advance generally in the direction of arrow 52.

Section A of FIG. 2 illustrates the initial stage of providing the metal strip 10 on an insulated film strip 54, such as a polymer including, for example Mylar. The film strip 54 has a top surface 56 and a bottom surface 58. The bottom surface 28 of the metal strip 10 is provided on the top surface 56 of the film strip 54. The metal strip 10 is coupled to the film strip 54, such as with a pressure and/or temperature sensitive adhesive. Optionally, the film strip 54 may have adhesive properties which are activated upon application of pressure and/or high temperature. The film strip 54 includes at least one carrier strip 60 with a plurality of pilot holes 62 provided along the length of the carrier strip 60. The pilot holes 62 enable the film strip 54 to be dispensed from and taken up onto a reel (not shown) through the various stages of manufacture.

Section B of FIG. 2 corresponds to an optional step of an initial stamping or separation stage at which a portion of film strip 54 and a portion of metal material 22 are removed, such as by stamping, thereby leaving a plurality of notches 66 extending laterally across the film strip 54. Optionally, lateral notches 66 may be arranged substantially parallel to axis 25 of each body 24 of metal connectors 18. Lateral notches 66 are stamped in the film strip 54 and metal materials 22 to separate metal connectors 18 on a series of corresponding separate film covers 70. Notches 66 separate adjacent metal connectors 18 and adjacent film covers 70. The metal connectors 18 are orientated to extend laterally across the film covers 70. Each metal connector 18 is held on a corresponding film cover 70 to form an insulative wire splice 50. The series of film covers 70 are coupled at one end to at least one carrier strip 60. As shown in FIG. 2, the film covers 70 extend between and are integral with a pair of carrier strips 60.

Section C of FIG. 2 corresponds to a final stamping stage at which the film strip 54 is further stamped to remove additional material from film covers 70. Optionally, triangular shaped notches 74 are stamped in the film strip 54 to form a substantially hourglass shaped notch 76 between each wire splice 50, as shown in FIG. 2. As a result of the final stamping stage of Section C, each film cover 70 is coupled to the carrier strip 60 only by a linkage portion 78 aligned substantially along axis 25 of each respective metal connector 18. Optionally, linkage portion 78 maybe substantially aligned with at least one pilot hole 62. Carrier strip 60, linkage portion 78, and film cover 70 are integral with each other, as shown in FIG. 2. Optionally, metal connector 18 and film cover 70 may be separated from carrier strip 60 by stamping or removing the linkage portion 78, so that the metal connector 18 and the film cover 70 may be utilized as an insulated wire splice 50 without the carrier strip 60. Further, the separated metal connector 18 and film cover 70 may be coupled to another carrier strip or an alternative support strip.

Section D of FIG. 2 corresponds to a folding stage at which the metal connector 18 and the film cover 70 are partially folded along axis 25, resulting in a pre-crimped insulated sleeve or wire splice 50 that is configured to receive terminal wires. Optionally, metal connector 18 and film cover 70 maybe folded together to form a substantially U-shaped channel 79. Optionally, metal connector 18 and film cover 70 maybe folded together to form another shape such as an open barrel. As the wire connector 18 is folded, the film cover 70 is similarly folded because the top surface 56 of the film cover 70 is adhered to the bottom surface 28 of the metal connector 18. The wire splice 50 illustrated in FIG. 2 is manufactured in a side-feed configuration. Optionally, the wire splices 50 may also be manufactured in an end-feed configuration (not shown).

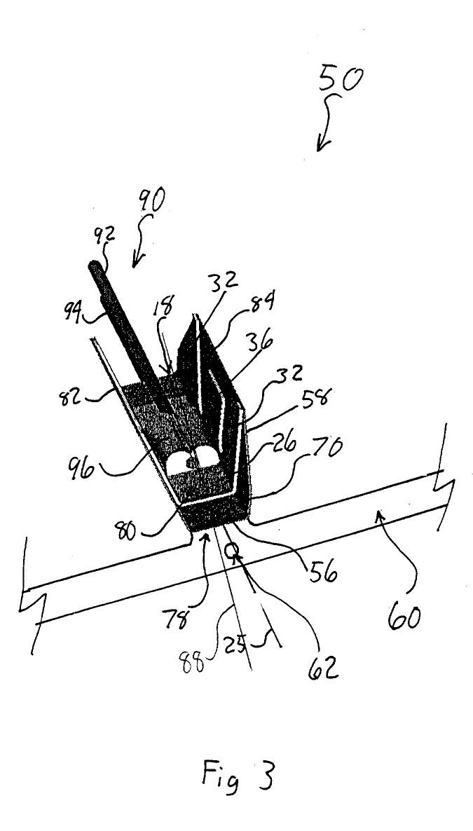

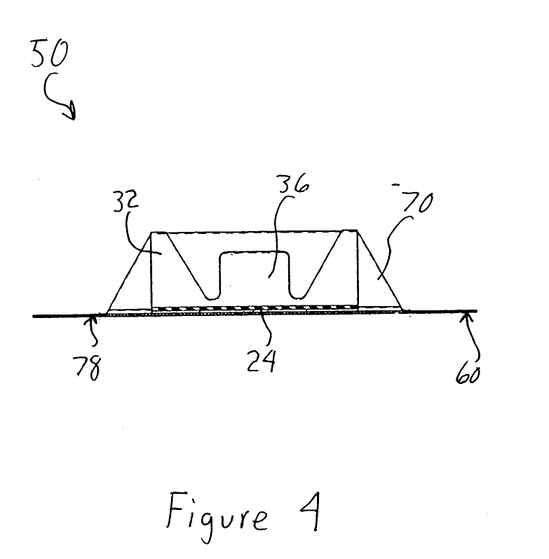

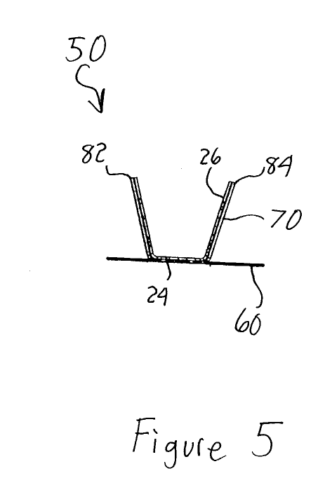

FIG. 3 is a top perspective view of a wire splice 50 that has been folded to a pre-crimped state while still coupled to a carrier strip 60. FIG. 4 is a side view of the wire splice 50 in FIG. 3. FIG. 5 is a front view of the wire splice 50 in FIG. 3. Because the film cover 70 is adhered to the metal connector 18, the metal connector 18 provides structural support for the film cover 70 giving shape to the film cover 70. As shown in FIG. 3, the substantially U-shaped channel 79 has a substantially planar base portion 80 with at least one of a pair of opposed crimp fingers 32 and a pair of opposed side extensions 36 projecting substantially perpendicular from the base portion 80. Optionally, at least one of the crimp fingers 32 and side extensions 36 may extend from the base portion 80 at an acute angle measured with respect to a normal axis 88 of base portion 80. Film cover 70 has opposed side edges 82 and 84. When in the pre-crimped state, the wire splice 50 receives a wire 90, which is substantially aligned along axis 25. As shown in FIG. 3, a plurality of wires, such as a multi strand wire 92 and a copper wire 94 maybe spliced together to form a splice tip 96. The splice tip 96 is received within the wire splice 50. Optionally, a pair of magnet wires and a lead wire maybe spliced together and placed within the wire splice 50.

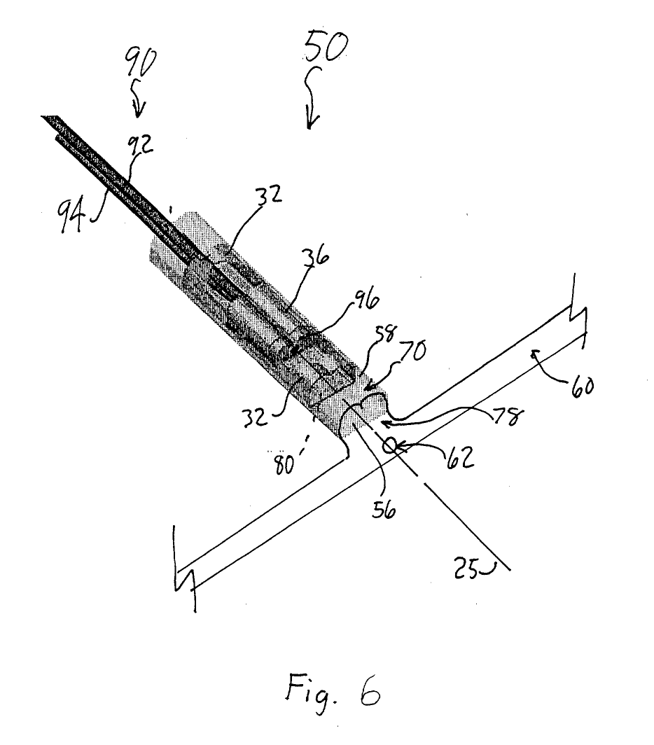

FIG. 6 is a top perspective view of a wire splice 50, when in a fully crimped state, securing the wire 90 therein. Once the wire 90 and splice tip 96 are disposed within the U-shaped channel 79 of the wire splice 50, the metal connector 18 along with the film cover 70 are bent or crimped to secure the wire 90 to the wire splice 50. As shown in FIG. 6, the pair of side extensions 36 are crimped around the splice tip 96, while one pair of crimp fingers 32 are crimped around the wire 90 and another pair of crimp fingers 32 are crimped toward each other. As crimp fingers 32 and side extensions 36 are crimped to secure the wire 90 to the wire splice 50, the side edges 82 and 84 of the film cover 70 are similarly crimped because the film cover 70 is adhered to the bottom surface 28 of the crimp fingers 32 and the side extensions 36. For example, when the pair of opposed crimp fingers 32 are crimped, the corresponding side edges 82 and 84 are similarly crimped so that each pair of crimp fingers 32 do not directly contact each other when crimped, but are separated from each other by at least the film cover 70 adhered to the bottom surface 28 of each crimp finger 32. Optionally, at least one crimp finger 32 may be crimped around the splice tip 96. Optionally, at least one side extension 36 may be crimped around the wire 90 and at least one crimp finger 32 may be crimped around the splice tip 96. Optionally, at least one crimp finger 32 may be crimped around the multi-strand wire 92 and at least one crimp finger 32 may be crimped around the copper wire 94.

The foregoing detailed description of the invention includes passages which are chiefly or exclusively concerned with particular parts or aspects of the invention. It is to be understood that this is for clarity and convenience, that a particular feature may be relevant in more than just the passage in which it is disclosed, and that the disclosure herein includes all the appropriate combinations of information found in the different passages. Similarly, although the various figures and descriptions thereof relate to specific embodiments of the invention, it is to be understood that where a specific feature is disclosed in the context of a particular figure, such feature can also be used, to the extent appropriate, in the context of another figure, in combination with another feature, or in the invention in general.

While the invention has been described in terms of various specific embodiments, those skilled in the art will recognize that the invention can be practiced with modification within the spirit and scope of the claims.

What is claimed is:

1. An insulated wire splice comprising:
a wire connector configured to receive and be secured to a wire; and
an insulating film cover secured to said wire connector.

2. The insulated wire splice of claim 1 wherein said wire connector has a body with at least one crimp finger configured to be crimped to a wire.

3. The insulated wire splice of claim 1 wherein said wire connector has a body with at least one side extension configured to be crimped to a wire.

4. The insulated wire splice of claim 1 wherein said insulating film cover is integral with an insulated carrier strip.

5. The insulated wire splice of claim 1 further comprising a plurality of insulating film covers joined with an insulated carrier strip, said plurality of insulating film covers each having a wire connector secured thereto.

6. The insulated wire splice of claim 1 wherein said wire connector and said insulating film cover are bent to form a substantially U-shaped channel.

7. A method for making a splice comprising:
providing a film strip comprising an insulated material; and
securing at least one wire connector to said film strip.

8. The method according to claim 7 wherein providing the film strip further comprises stamping notches in the film strip to separate adjacent slices.

9. The method according to claim 7 further comprising securing the wire connector to the film strip when the wire connector is in a precrimped state.

10. The method according to claim 7 further comprising heating the film strip to secure the wire connector to the film strip when the wire connector is in a precrimped state.

11. The method according to claim 7 further comprising stamping the wire connector to form a body having opposed side extensions.

12. The method according to claim 7 further comprising stamping the wire connector to form a body having opposed crimp fingers and side extensions.

13. The method according to claim 7 further comprising orienting a plurality of wire connector on the film strip to extend laterally across the film strip.

14. The method according to claim 7 further comprising folding the wire connector and corresponding film strip to form a substantially U-shaped channel configured to receive a wire.

15. A contact assembly comprising:
an insulated carrier film formed integral with a series of film covers;
a series of connectors held on corresponding film covers; and
an insulated carrier strip joined with said film covers.

16. The contact assembly according to claim 15 wherein said carrier film is stamped to form adjacent film covers.

17. The contact assembly according to claim 15 wherein said series of connectors and said corresponding film covers are bent to form a substantially U-shaped open barrel.

18. The contact assembly according to claim 15 wherein said series of connectors are adhesively secured to said corresponding film covers.

19. The contact assembly according to claim 15 wherein each of said series of connectors comprise a body having at least one crimp finger configured to be crimped to a wire.

20. The contact assembly according to claim 15 wherein each of said series of connectors comprise a body having at least one side extension configured to be crimped to a wire.
